(19) United States
(12) Patent Application Publication
(10) Pub. No.: US 2012/0029681 A1
(43) Pub. Date: Feb. 2, 2012

(54) IMAGE ENGRAVING DEVICE

(75) Inventor: Yuichi Hoshiyama, Tokyo (JP)

(73) Assignee: SEMCO CORPORATION, TOKYO (JP)

(21) Appl. No.: 13/263,048

(22) PCT Filed: Apr. 7, 2009
(86) PCT No.: PCT/JP2009/001612

§ 371 Date: Oct. 5, 2011

(51) Int. Cl. G06F 19/00

(52) U.S. Cl. 700/117

(57) ABSTRACT

The present invention provides an image engraving device for engraving a special composite paper or a thin plastic plate by moving an engraving needle and a target plate to be engraved relative to each other such that the engraving needle scans the target plate, the image engraving device operating only if a license code is input and is certified correct. The image engraving device has a license code input part for inputting a license code, a license code certifying part certifying whether the input license code is correct or not, and a controller controlling to allow the image engraving device to operate only if the license code is certified correct. With this configuration, the image engraving device solves the problem. In order to secure the certification of the license code, an engraving needle driver and a target plate driver are provided certifying parts, respectively. The operation of the certifying parts is hard-coded to prevent the image engraving device from fraudulently certifying. This configuration allows the authenticated image engraving device to operate, and it secure reliability of engraved plates that are target plates having been engraved.

### BACKGROUND OF THE INVENTION

1. Field of the Invention

The present invention relates to an image engraving device for engraving a special composite paper or a thin plastic plate by moving an engraving needle and a target plate to be engraved relative to each other such that the engraving needle scans the target plate, the image engraving device operating by at least one of a predetermined time and a predetermined number of times to carry out the engraving.

2. Description of Related Art

An image engraving device engraves a special composite paper or a thin plastic plate by moving an engraving needle and a target plate to be engraved relative to each other such that the engraving needle scans the target plate (See Patent Literature 1). In this image engraving device, the target plate is horizontally moved on a base and the engraving needle vertically descends to scrape off a surface material from the target plate made of paper, plastic or the like. With this, a watermark engraving is carried out on the target plate to form a watermark engraved plate. The engraved plate is used as an identification card or a security sheet for an important document (See Patent Literatures 2 and 3).

The image engraving device enables to make confidential papers such as identification cards and important documents. In order to ensure security, the image engraving device may operate by a predetermined time or a predetermined number of times to carry out the engraving only if a license code is input to be collated and then the input license code is correct. However, there is no method of controlling the operation of the image engraving device based on the license code.

Patent Literature 1: Japanese Unexamined Patent Application Publication No. H05-024394

Patent Literature 2: Japanese Unexamined Patent Application Publication No. 2007-118395

Patent Literature 3: Japanese Unexamined Patent Application Publication No. 2007-130855

### SUMMARY OF THE INVENTION

A problem to be solved by the invention is what it is impossible to operate an image engraving device by a predetermined time or a predetermined number of times to carry out engraving only if a license code is input and is certified correct.

A first aspect of the present invention is to provide an image engraving device comprising a license code input part receiving an input of a license code, a license code certifying part certifying whether the license code received by the license code input part is correct or not, and a controller controlling to allow the image engraving device to operate by at least one of a predetermined time and a predetermined number of times to carry out engraving only if the license code is certified correct.

A second aspect of the present invention is to provide an image engraving device comprising an engraving needle driver driving an engraving needle, and a target plate driver driving a target plate to be engraved. The engraving needle and the target plate are moved relative to each other such that the engraving needle scans the target plate to carry out engraving on the target plate. The image engraving device of the second aspect further comprises a license code input part receiving an input of a license code, a license code certifying part certifying whether the license code received by the license code input part is correct or not, and a controller controlling to allow the image engraving device to operate by at least one of a predetermined time and a predetermined number of times to carry out engraving only if the license code is certified correct.

According to the first aspect, the image engraving device comprises the license code input part receiving the input of the license code, the license code certifying part certifying whether the license code received by the license code input part is correct or not, and the controller controlling to allow the image engraving device to operate by at least one of the predetermined time and the predetermined number of times to carry out engraving only if the license code is certified correct. Therefore, only if an image engraving device is authorized, it operates to carry out the engraving. It is possible to control sources of engraved plates and limit a number of engravings, so that it ensures reliability of the engraved plates.

According to the second aspect, the image engraving device comprising the engraving needle driver driving the engraving needle, and the target plate driver driving the target plate to be engraved. The engraving needle and the target plate are moved relative to each other such that the engraving needle scans the target plate to carry out engraving on the target plate. The image engraving device of the second aspect further comprises the license code input part receiving the input of the license code, the license code certifying part certifying whether the license code received by the license code input part is correct or not, and the controller controlling to allow the image engraving device to operate by at least one of the predetermined time and the predetermined number of times to carry out engraving only if the license code is certified correct. Therefore, only if an image engraving device is authorized, it operates to carry out the engraving. It is possible to control sources of engraved plates and limit a number of engravings, so that it ensures reliability of the engraved plates.

### BRIEF DESCRIPTION OF THE DRAWINGS

FIG. 1 is a functional block diagram illustrating an image engraving device according to the embodiment of the present invention; and

FIG. 2 is a flow chart of the image engraving device according to the embodiment of the present invention.

### DETAILED DESCRIPTION OF EMBODIMENTS

An image engraving device according to the present invention receives an input of a license code, certifies if the input license code is correct, and controls to allow the image engraving device to operate by the predetermined time or the predetermined number of times to carry out engraving only if the license code is certified correct.

### Embodiment 1

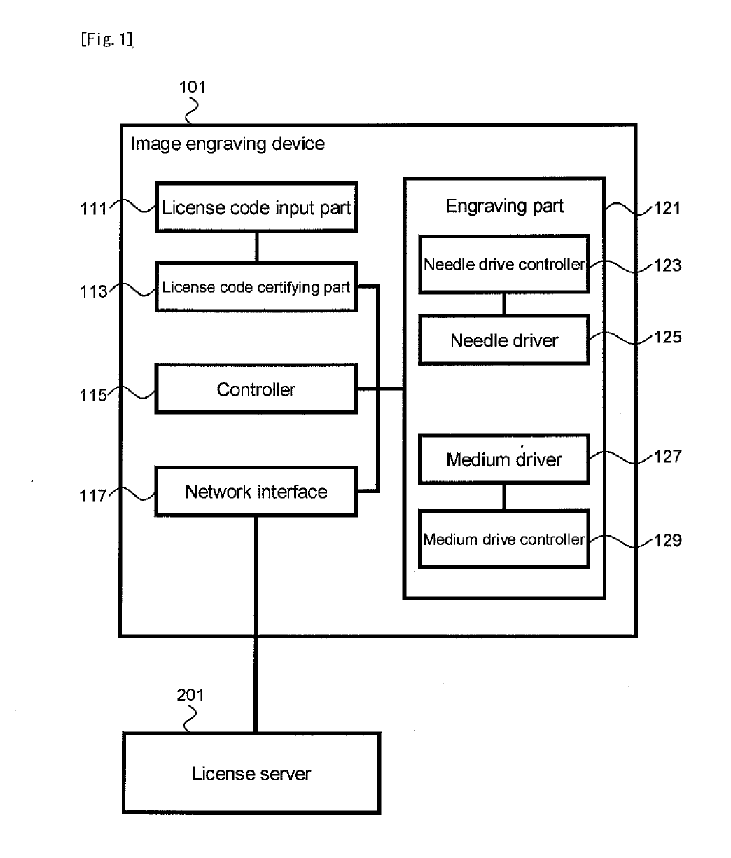

FIG. 1 is a functional block diagram illustrating an image engraving device 101 according to an embodiment of the present invention.

The image engraving device 101 has a license code input part 111, a license code certifying part 113, a controller 113, a network interface 117, and an engraving part 121. The engraving part 121 has a needle drive controller 123, a needle driver 125, a medium driver (target plate driver), and a medium drive controller (target plate drive controller).

The image engraving device 101 is connected to an external license server 201 through the network interface 117.

Each functional part of the image engraving device 101 will be explained.

The license code input part 111 has a keyboard or a touch panel to receive an input of a license code from a user and transfers the input license code to the license code certifying part 113.

The license code certifying part 113 certifies whether the input license code is correct or not. In order to certify the input license code, an own authentication code is stored in a ROM (not shown) or other nonvolatile memory of the respective image engraving device 101. The license code certifying part 113 collates the input license code through an irreversible calculation on the basis of a calculation function thereof. When carrying out the calculation, the license code certifying part 113 may check to see if the input license code is valid in a given period with the use of time and date.

At the time of the certification, the license code certifying part 113 interprets an available time incorporated into the input license code to decide an operable time of the device. Alternatively, the license code certifying part 113 decides a permissible number of times to carry out engraving (permissible number of engravings) on the basis of an incorporation of the input license code. Alternatively, the license code certifying part 113 decides both the operable time and the permissible number of times to carry out the engraving. The decision is set into the controller.

The license code to be input is distributed to a user by a producer or a manger of the device.

The controller 115 controls to allow the engraving part to operate by at least one of the operable time and the permissible number of times to carry out engraving (permissible number of engravings).

The engraving part 121 is a hardware to engrave a surface of a medium (target plate) such as a special composite paper or a plastic thin plate horizontally arranged in the image engraving device 101 by scanning.

The image engraving device 101 has an engraving needle movable in a vertical direction and a medium support table that supports the medium (target plate) and reciprocates in a horizontal direction for scanning. The image engraving device 101 also has the needle driver 125 and the medium driver 127 that drive the engraving needle and the medium support table, respectively.

Each functional part in the engraving part 121 will be explained.

The needle driver 125 has the engraving needle and an actuator for vertically driving the engraving needle. The actuator controls engraving depths with respect to the target plate. The needle driver 125 may have a function to horizontally drive the engraving needle as well as the function to vertically drive it in order to work together the medium driver in the horizontal direction.

The needle drive controller 123 independently certifies the input license code at the license code input part 111 and allows the needle driver 125 to operate by one or both of a predetermined time and a predetermined number of engravings only if the license code is certified correct. The needle drive controller 123 is directly embodied by an IC as a hardware for controlling the needle drive. This results in complicating modifications of a circuit for the operation of the needle drive controller 123 compared with modifications of a program, to securely certify the license code. Even if the controller 115 allows the needle driver 125 to operate through any modifications, the needle driver 125 is not operable unless the input license code is certified correct at the needle drive controller 123.

The medium driver 127 (target plate driver) has the support table that supports the medium (target plate such as special composite paper or plastic thin plate) and an actuator that horizontally drives the support table. The actuator controls engraving positions in a plane of the target plate.

The medium drive controller 129 (target plate drive controller) independently certifies the input license code at the license code input part 111 and allows the medium driver 127 to operate by one or both of a predetermined time and a predetermined number of engravings only if the license code is certified correct. The medium drive controller 129 is directly embodied by an IC as a hardware for controlling the medium drive. This results in complicating modifications of a circuit for the operation of the medium drive controller 129 compared with modifications of a program, to securely certify the license code. Even if the controller 115 allows the medium driver 127 to operate through any modifications, the medium driver 127 is not operable unless the input license code is certified correct at the medium drive controller 129.

The network interface 117 connects the image engraving device 101 and the external license server 201.

The license code certifying part 113 further secures certifying of the license code through the license server 201. For example, if a malicious user deranges an internal clock of the image engraving device 101 to change the operable time, the license server 201 collates the time of the internal clock to find the fraudulent manipulation and rejects the certification at the deranged image engraving device 101.

[Flow Chart]

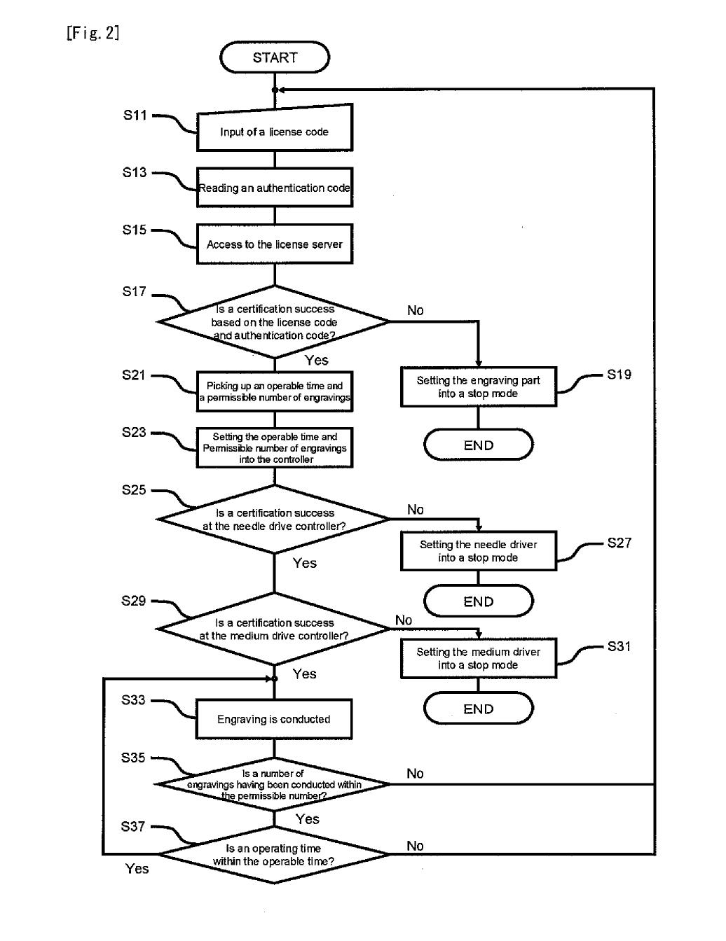

A flow chart of operation of the image engraving device 101 according to the embodiment of the present invention will be explained with reference to FIG. 2.

This flow chart represents a case that a license code includes both the operable time and the permissible number of engravings and the image engraving device is operable by the permissible number of engravings in the operable time.

S11: The license code input part 111 receives an input of a license code.

S13: The license code certifying part 113 reads an own authentication code corresponding to the image engraving device 101 in which the license code is input at the license code input part 111.

S15: The license code certifying part 113 certifies whether a clock time of the image engraving device 101 or not by accessing the license server 201 and also certifies whether the authentication code and the input license code are valid or not.

S17: The clock time is certified correct and the authentication code and the input license code are certified valid. The license code certifying part 113 collates the input license code with respect to the authentication code. If the collation is successful, the flow chart shifts to S21. If the collation is failure, the flow chart shifts to S19.

S19: The controller 115 sets the engraving part 121 into a stopped mode to inhibit the engraving part 121 from operating because the collation is failure.

S21: The license code certifying part 113 interprets the input license code to pick up data of the operable time and the permissible number of engravings from the license code because the collation is successful.

S23: The license code certifying part 113 sets the operable time and the permissible number of engravings obtained at S21 into the controller 115.

S25: The needle drive controller 123 certifies whether the input license code is correct or not with use of the hardware that is the circuit in the IC for controlling the needle drive. If the license code is certified correct, the flow chart shifts to S29. If the license code is not certified, the flow chart shifts to S27.

S27: The needle drive controller 123 sets the needle driver 125 into a stopped mode to inhibit the needle driver 125 from operating because the certification is failure.

S29: The medium drive controller 129 certifies whether the input license code is correct or not with use of the hardware that is the circuit in the IC for controlling the medium drive. If the license code is certified correct, the flow chart shifts to S33. If the license code is not certified, the flow chart shifts to S31.

S31: The medium drive controller 129 sets the medium driver 127 into a stopped mode to inhibit the medium driver 127 from operating because the certification is failure.

S33: The image engraving device passes all the collations or certifications, so that the engraving part 121 engraves according to an engraving request.

S35: The controller 115 adds “1” at a counter for a number of engravings therein and determines whether the counted number is within the permissible number of engravings set in S23 or not. If the counted number is within the permissible number, the flow chart shifts to S37. If the counted number exceeds the permissible number, the flow chart shifts to S11 to wait for a new input of a license code.

S37: The controller 115 determines whether an operating time is within the operable time set in S23 on the basis of the clock time of the image engraving device or not. If the operating time is within the operable time, the flow chart shifts to S33 to wait for a new engraving request. If the operating time exceeds the operable time, the flow chart shifts to S11 to wait for a new input of a license code.

With above-mentioned a set of operation, it is possible to control to allow the image engraving device to operate only if the input of the license code is valid.

The followings are the effects to be embodied by the image engraving device according to the embodiment of the present invention.

The license code to be input is distributed to a user by a producer or a manger of the image engraving device, to allow the image engraving device to operate (by specifying the operable time and the permissible number of engraving). Therefore, it is possible to control the image engraving device and engraved plates that are the target plates have been engraved.

With the license code to allow the image engraving device to operate within a predetermined operable time, even if a subsequent acquire is a malicious forger of confidential papers, the image engraving device is not operable after passing the predetermined operable time.

With the license code to allow the image engraving device to operate and engrave a predetermined permissible number of target plates, it improves reliability of confidential papers such as ID cards (identification cards) to be engraved by the image engraving device.

With the connection to the license server 201, it is possible to prevent the image engraving device from fraudulently operating with a deranged internal clock of the image engraving device.

The image engraving device has the drive controllers (the needle drive controller 123 and medium drive controller 129) to certify the input license code that are directly connected to the needle driver 125 and the medium driver 127 as the hardware in the engraving part 121 in addition to the license code certifying part 113 and the controller 115 to naturally certify the input license code. The drive controllers are integrated with the hardware such as an IC, so that it results in complicating modifications of the drive controllers compared with modifications of a program. The image engraving device further secures the reliability of the certification of the license code.

According to the embodiment of the present invention, plural certifications or collations are carried out to prevent the image engraving device from fraudulently certifying or collating the input license code. It is not necessarily to carry out all the certifications or collations in the embodiment. For example, an image engraving device may have only one of the needle drive controller 123 and medium drive controller 129 in an engraving part. Alternatively, an image engraving device may omit both the needle drive controller 123 and the medium drive controller 129 and certify an input license code at the license code certifying part 113 and controller 115 in the body of the image engraving device.

In any cases, the license server may be provided for the image engraving device or may be omitted.

According to the embodiment, the license code is input through the keyboard or the like. The way to input the license code is not limited. The input of the license code may be carried out with use of an IC card storing the license code to be read from a reader or may be carried out through the network interface. Namely, known data entry method may be used for the input of the license code.

1. An image engraving device comprising:
a license code input part receiving an input of a license code;
a license code certifying part certifying whether the license code received by the license code input part is correct or not; and
a controller controlling to allow the image engraving device to operate by at least one of a predetermined time and a predetermined number of times to carry out engraving only if the license code is certified correct.

2. The image engraving device of claim 1, wherein the license code certifying part has an own authentication code of the respective image engraving device and collates the input license code with respect to the authentication code for certifying the input license code.

3. The image engraving device of claim 2, wherein the authentication code is hard-coded.

4. The image engraving device of any one of claims 1 to 3, wherein the license code certifying part sends an inquiry on the basis of the input license code before certifying the input license code.

5. An image engraving device comprising an engraving needle driver driving an engraving needle and a target plate driver driving a target plate to be engraved, the engraving needle and the target plate being moved relative to each other such that the engraving needle scans the target plate to carry out engraving on the target plate, the image engraving device further comprising:
a license code input part receiving an input of a license code;
a license code certifying part certifying whether the license code received by the license code input part is correct or not; and
a controller controlling to allow the image engraving device to operate by at least one of a predetermined time and a predetermined number of times to carry out engraving only if the license code is certified correct.

6. The image engraving device of claim 5, wherein the engraving needle driver operates by at least one of the predetermined time and the predetermined number of times to carry out engraving only if the license code is certified correct.

7. The image engraving device of claim 5, wherein the target plate driver operates by at least one of the predetermined time and the predetermined number of times to carry out engraving only if the license code is certified correct.
